(19) United States
(12) Patent Application Publication
(10) Pub. No.: US 2009/0109352 A1
(43) Pub. Date: Apr. 30, 2009

(54) APPARATUS, SYSTEM AND METHOD FOR MOUNTING A DISPLAY SCREEN IN A VEHICULAR COMPARTMENT

(76) Inventors: BRIAN E. LEWIS, Georgetown, TX (US); David E. Lewis, Orange, CA (US); Robert Fairchild, Santa Ana, CA (US)

Correspondence Address: DILLON & YUDELL LLP, 8911 NORTH CAPITAL OF TEXAS HWY, SUITE 2110, AUSTIN, TX, 78759, US

(21) Appl. No.: 11/926,282

(22) Filed: Oct. 29, 2007

(51) Int. Cl. H04N 5/64

(52) U.S. Cl. 348/837; 348/E05.132

(57) ABSTRACT

A display screen mount apparatus. The apparatus includes a mounting frame positioned adjacent a vehicle ceiling. The mounting frame includes an attachment interface applying the weight of the apparatus to an external vehicle roof surface. A slide assembly includes a stationary end coupled to the mounting frame and an extensible member that is horizontally extensible from the mounting frame. A vertical support frame for supporting a display screen is pivotally coupled to the extensible member such that the support frame may be angularly rotated between a horizontal storage position and a vertical display position. A housing coupled to the support frame provides a housing recess for receiving the screen. The apparatus further includes an L-shaped fulcrum lever having a user-actuated arm and a spring-actuated arm. The user-actuated arm is coupled in parallel with the support frame. A pneumatic spring is coupled between and applies an expansive force between the slide assembly and the spring-actuated arm.

### BACKGROUND OF THE INVENTION

1. Technical Field

The present invention relates generally to the field of mounting devices and apparatuses for mounting and positioning a display device, such as an LCD screen, within a vehicular interior. More particularly, the present invention relates to a display screen mount apparatus including a movable display screen housing and pivot control linkage mechanism that enables large and heavy display screens to be securely and safely stored when the vehicle is moving and further provides safe and stable deployment of the display screen when viewing is desired.

2. Description of the Related Art

Flat panel displays such as liquid crystal displays (LCDs) have become an increasingly popular substitute for cathode ray tube displays (CRTs) in many video display applications. The weight and fragility of such displays renders mounting and positioning a substantial challenge, particularly in dynamic environments such as automobiles, boats, airplanes, rail cars etc. A flat panel display may be mounted in an affixed or movable manner to a fixed structure, such as an interior wall panel or ceiling. Positioning and handling of a flat panel display may be particularly problemmatic for the limited space environment of a vehicle interior, given the size, weight, and fragility of the display.

Prior art mounting devices enable adjustable vertical positioning and display screen tilting to provide an optimum viewing angle of a flat panel display for stationary as well as mobile applications. The prior art mounting and positioning devices include use of friction controlled hinges, spring biased mechanical linkages, and various mechanical latches. While providing sufficient loading bearing support for relatively small and unobtrusive panel displays, the prior art solutions fail to address many of the problems associated with mounting and positioning large and heavy flat panel displays within a limited space and mechanically dynamic environment of a vehicle interior.

It can therefore be appreciated that a need exists for an apparatus, device, and system for addressing problems posed by mounting and positioning increasingly large and heavy video displays within a vehicle interior such as the interior of a recreational vehicle. The present invention addresses these and other needs unresolved by the prior art.

### SUMMARY OF THE INVENTION

A display screen mount apparatus, device, system, and method for mounting the same are disclosed herein. In one embodiment, the apparatus includes a mounting frame coupled to and supported by an exterior roof surface and positioned adjacent a vehicle interior ceiling. The mounting frame includes an attachment interface applying the weight of the apparatus to an external, substantially horizontal vehicle surface such as a vehicle roof surface. The apparatus further includes a slide assembly having a stationary end fixedly coupled to the mounting frame and having an extensible member that is horizontally extensible from the mounting frame. A vertical support frame supporting a display screen is pivotally coupled to the extensible member such that the support frame may be angularly rotated between a horizontal storage position and one or more near-vertical display positions. A display screen housing is fixedly coupled to the support frame and provides a recess in which the display screen is housed in both the storage and display position. The apparatus further includes an L-shaped fulcrum lever having a user-actuated arm transversely disposed with respect to a spring-actuated arm. The user-actuated arm is coupled in substantially parallel alignment with the support frame such that the support frame provides cantilevered support to the spring-actuated arm. A pneumatic spring is coupled between and applies an expansive force between the slide assembly and the spring-actuated arm of the L-shaped fulcrum lever.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 illustrates a perspective view of a display screen mount apparatus in accordance with one embodiment of the present invention;

FIG. 2 depicts a cross-section view of the display screen mount apparatus shown in FIG. 1;

FIG. 3 illustrates an alternate cross-section view of the display screen mount apparatus shown in FIGS. 1 and 2;

FIG. 4 depicts a display screen mount apparatus mounted within a vehicle interior in accordance with an alternate embodiment of the present invention;

FIG. 5 illustrates an alternate perspective view of the display screen mount apparatus shown in FIG. 4;

FIGS. 6A and 6B depict a perspective view and a cross-section view, respectively, of a roof mount support plate that are included within the display screen mount apparatus in accordance with the present invention;

FIG. 7 illustrates a partial perspective view of a mounting frame including outrigger tab panel supports in accordance with a preferred embodiment; and

FIGS. 8A-8D depict views of a display screen mount apparatus in various stages of panel display storage and deployment in accordance with an alternate embodiment of the present invention.

### DETAILED DESCRIPTION OF ILLUSTRATIVE EMBODIMENT(S)

The present invention is described in a preferred embodiment in the following description with reference to the figures. While this invention is described in terms of the best mode for achieving this invention's objectives, it will be appreciated by those skilled in the art that variations may be accomplished in view of these teachings without deviating from the spirit or scope of the present invention. Furthermore, when used and unless otherwise stated, terms such as “horizontal,” “vertical,” “upper,” “lower,” “front,” “rear,” “over,” and “under,” and similar position related terms are not to be construed as limiting the invention to a particular orientation. Instead, such terms are to be construed only on a relative basis reflecting the relative position and orientation of the various components shown in the accompanying depicted embodiments.

The present invention is directed to an apparatus, device, system, and method for mounting a display device such as an LCD flat screen display device within a vehicular compartment. In a preferred embodiment, the invention is generally directed to mounting devices and apparatuses for mounting a relatively large and heavy flat panel display device, such as an LCD screen, adjacent to a relatively lightweight mounting strata such as roof and ceiling structures of recreational vehicles (RVs). The mounting apparatus includes features for securing a display screen during travel in a manner such that the screen can be horizontally stored adjacent to a horizontal mounting surface. The apparatus further includes features for deploying the display screen in one or more vertical or near-vertical viewings angles which the vehicle is stationary.

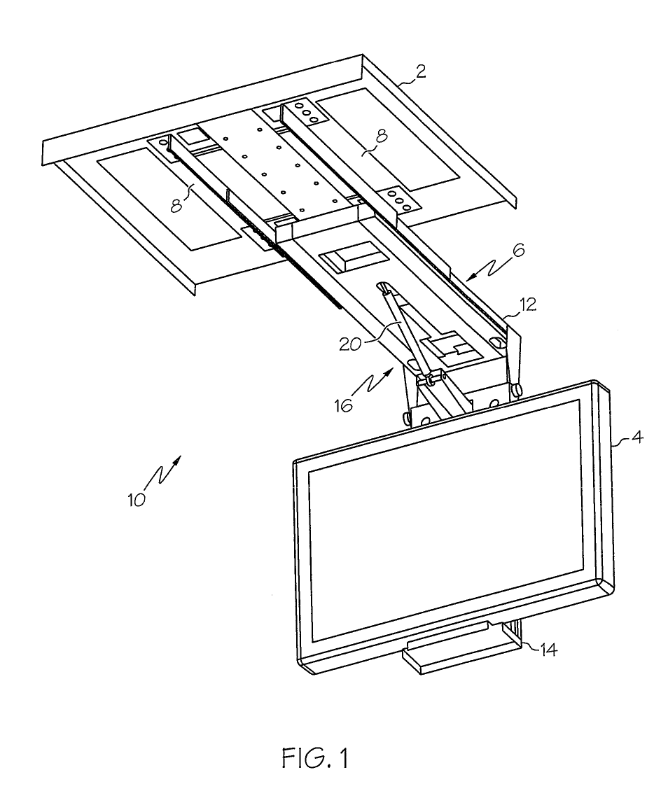

As depicted and explained in further detail below with reference to the illustrated embodiments, the invention generally comprises a display screen mounting apparatus including features enabling large and fragile flat panel display screens to be safely and securely mounted within the restricted confines of a vehicle interior. With reference now to the figures, wherein like reference numerals refer to like and corresponding parts throughout, and in particular with reference to FIG. 1, there is illustrated a perspective view of a display screen mount apparatus 10 in accordance with one embodiment of the present invention. As shown in FIG. 1, display screen mount apparatus 10 generally comprises a slide assembly 6 coupled to a mounting frame 2. As depicted and explained in further detail below with reference to the following figures, mounting frame 2 includes an attachment interface having novel and advantageous features for securely coupling the mount apparatus to an RV roof structure.

Slide assembly 6 includes a stationary base portion 8 fixedly coupled to mounting frame 2. Slide assembly 6 further includes a horizontally extensible slide member 12 that is slidably or otherwise movably engaged with stationary base 8. It should be noted that stationary base 8 may be a distinct portion of slide assembly 6 coupled to mounting frame 2, or may alternately be integrally incorporated as a part of mounting frame 2 to which the extensible slide member 12 is engaged. Extensible slide member 12 may be a compound slide unit comprising multiple telescopically engaging slide or roller units. In a preferred embodiment, slide assembly 6 comprises ball bearing roller extension units for facilitating horizontal extension of a heavy display screen to and from mounting frame 2. Furthermore, slide assembly 6 preferably includes multiple lock or stop points disposed at specified positions along its horizontally extended length to enable a user to adjustably set a desired point of horizontal positioning of the slide assembly 6.

Display screen mount apparatus 10 further includes a display support frame 14 that is pivotally coupled to the distal end of extensible slide member 12. As shown in FIG. 1, support frame 14 is fixedly coupled to and supports a display screen 4 when the support frame/display unit is radially extended from mounting frame 2. In one embodiment, display screen 4 is an LCD flat panel display that may be coupled to display support frame 14 using any one or more possible mechanical fastener and adhesive fastening means.

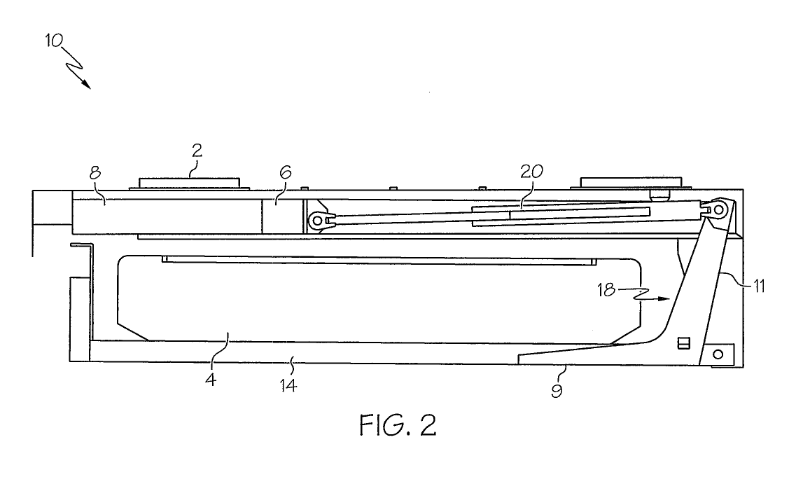

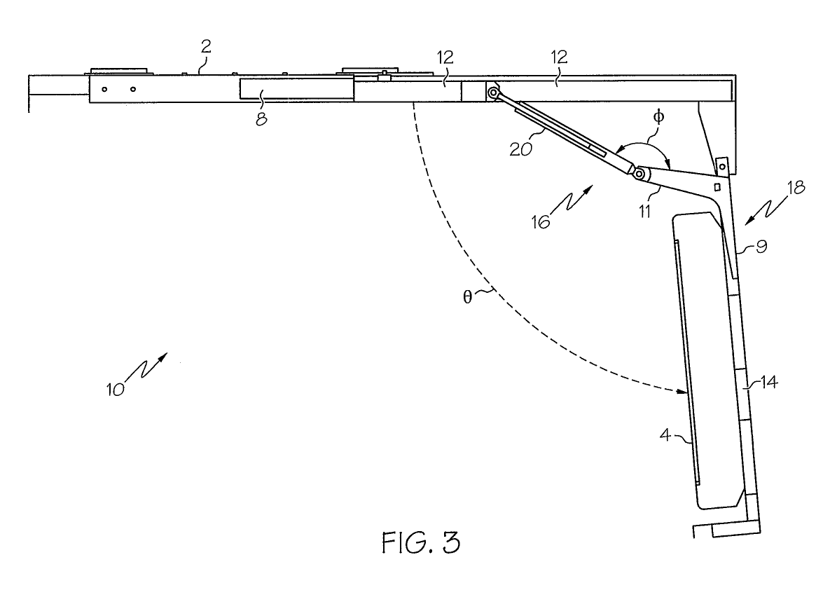

Display screen mount apparatus 10 further includes a pivot control mechanism 16 for facilitating and controlling radial extension of support frame 14 between a horizontal stowage position adjacent mounting frame 2 and the vertically deployed position shown in FIG. 1. As illustrated and explained with reference to FIGS. 2 and 3, pivot control mechanism 16 includes features for providing stability for downward radial extension of a heavy display screen 4 while also providing advantageous leverage when the display screen 4 is extended radially upward and folded into a storage position.

Referring now to FIGS. 2 and 3 there are depicted alternate cross-section views of display screen mount apparatus 10 showing the structural and operative features of pivot control mechanism 16. FIG. 2 illustrates a cross-section view of display screen mount apparatus 10 in the folded storage position and FIG. 3 illustrates a cross-section view of the apparatus in a vertically deployed position. As shown in the depicted views, pivot control mechanism 16 is a compound mechanical linkage generally comprising an L-shaped fulcrum lever 18 coupled to a pneumatic spring 20.

L-shaped fulcrum lever 18 is preferably a substantially rigid and integral member formed of a metallic alloy or polymer compound. In the depicted embodiment, L-shaped fulcrum lever 18 comprises a user-actuated arm 9 joined with a spring-actuated arm 11 and formed in the illustrated substantially transverse, L-shaped configuration. User-actuated arm 9 is coupled and disposed in substantially parallel disposition to support frame 14 and display screen 4. Spring-actuated arm 11 extends transversely from the parallel aligned support frame/user-actuated arm unit and in this manner is supported in a cantilevered manner by support frame 14. The free end of spring-actuated arm 11 is pivotally coupled to an end of pneumatic spring 20, the other end of which is coupled to extensible slide member 12 of slide assembly 6.

In the foregoing manner and as illustrated in FIGS. 2 and 3, pneumatic spring 20 is coupled between the horizontally extensible end of slide assembly 6 and spring-actuated arm 11 of fulcrum lever 18. In this configuration, pneumatic spring 20 is a spring member applying an expansive force between its pivot coupling to extensible slide member 12 and its pivot coupling to spring-actuated arm 11. In one embodiment, pneumatic spring 20 is a gas spring that uses any combination of enclosed gas pressures and/or elastic mechanical springs such as coil springs to achieve its spring member function. In a preferred embodiment, pneumatic spring 20 also includes an internal air valve damping mechanism to damp and linearize the spring response. Pneumatic spring 20 may comprise a compressed gas contained in a cylinder, the contained gas being variably compressed by a piston to exert an expansive force between the pivotal coupling points at the end of extensible slide member 12 and spring-actuated arm 11 of fulcrum lever 18. As shown in FIG. 3, when support frame 14 is radially extended downward to an angular displacement θ from mounting frame 2, spring-actuated arm 11 is radially positioned at an angular displacement φ from pneumatic spring 20.

The embodiment depicted in FIGS. 2 and 3 effectuates spring-facilitated and spring-stabilized display screen deployment and storage in the following manner. When support frame 14 is initially in a storage position substantially parallel to mounting frame 2 as shown in FIG. 2, φ is greater than 180°. In this position, pneumatic spring 20 applies a force to spring-actuated arm 11 which is translated by L-shaped fulcrum lever 18 to support frame 14, urging the support frame upwardly in the folded, storage position shown in FIG. 2. In this manner, the configuration of pneumatic spring 20, as operatively coupled between slide member 12 and support frame 14 via fulcrum lever 18, provides stability to a relatively heavy display screen 4 when positioned in the storage position and when initially retracted and pivoted such as by a user for viewing deployment of the screen.

The same dynamic linkage mechanism that enables pneumatic spring 20 to stabilize initial downward radial extension of display screen 4, also facilitates upward radial extension of display screen 4. Namely, when support frame 14 is initially in the vertically deployed position depicted in FIG. 3, the support frame may be manually or otherwise urged radially upward to be folded into the storage position shown in FIG. 2. As support frame 14 is rotated upwardly, the angle φ between pneumatic spring 20 and spring-actuated arm 11 increases from less than 180° to beyond 180°. Once φ is greater than 180°, the lever force applied by pneumatic spring 20 cooperates with the user-applied force applied to user-actuated arm 9 to facilitate the final angular displacement (i.e. θ decreasing below 90° and approaching 0°) of the display screen/support frame assembly over an angular displacement at which the otherwise unsupported portion of the display screen's weight is greatest. In the foregoing manner, the depicted disposition of pneumatic spring 20 between the horizontally extensible end of slide assembly 6 and spring-actuated arm 11 provides sufficient resistance to enable safe and controlled initial downward radial extension of the heavy display screen 4 and likewise facilitates the final upward radial extension of the display screen.

In addition to facilitating initial downward extension and final upward extension of display screen 4, pivot control mechanism 16 similarly provides a dual function as related to later downward and earlier upward radial extensions of the support frame/display structure. Namely, when user-actuated arm 9 is rotated downwardly, such as via manual actuation of support frame 14, past the fulcrum lever centerline at which φ is equal to 180° (i.e., point at which the centerline of pneumatic spring 20 is axially aligned with spring-actuated arm 11), the transverse disposition of spring-actuated arm 11 with respect to user-actuated arm 9 results in the expansive spring force assisting rather than resisting further downward deployment of support frame 14. In this manner, pneumatic spring 20 assists further downward extension of display screen 4 when the display screen is in a relatively stable position. More significantly, the outward force applied by pneumatic spring 20 via fulcrum lever 18 provides stability and resistance to the weight of display screen 4 when the display screen is positioned in a past-vertical viewing deployment in which θ is greater than 90°.

In the foregoing manner, the dynamic mechanical linkage provided by pivot control mechanism 16 provides a display screen positioning as well as damping function that is particularly advantageous storing and positioning a heaving display screen within a vehicle interior.

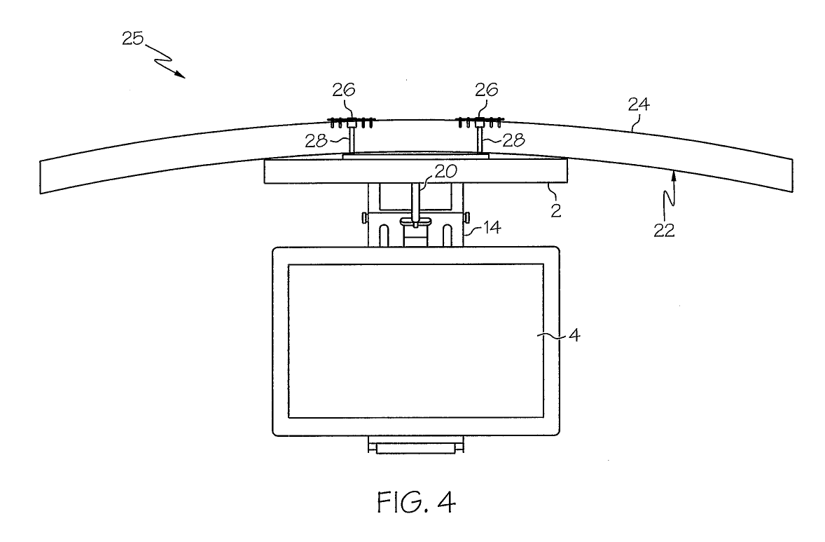

In the embodiment shown in FIGS. 4-6, the invention further comprises features for attaching the display screen mount apparatus to a roof surface of a vehicle such as an RV. Several features characteristic of RVs in particular pose significant problems for mounting large and heavy display screens. One such feature is the need, prompted by limited interior space, to maximize utilization of the interior lateral walls of an RV such as with appliances, furniture, etc. Such space crowding results in insufficient available vertical surface space to mount a display screen, thus giving rise to a need to mount the display screen to a substantially horizontally surface such as a ceiling or roof structure.

The need to mount the display in an overhead manner renders ceiling and roof design and structure a significant aspect of consideration for mounting a relatively large and heavy display screen. Namely, due to overall vehicle weight and strength and other structural limitations and requirements applicable to RVs, the interior ceiling of an RV (i.e., the overhead interior surface that bounds the overhead area of the RV compartment) is constructed of relatively lightweight material not well suited for supported heavy loads. As known in the art, the roof structure above the ceiling surface is typically a multi-layered structure comprising structural lamination layers interleaved between multiple bonded foam layers or some equivalent multilayered variant. Consistent with the need to minimize overall vehicle weight and to address the additional need for insulation adequate for extended living quarters, the roof structures of RVs are generally comprised of multiple lightweight layers that are arched to provide sufficient load bearing support for the many exterior articles such as air conditioning units, satellite dishes, and miscellaneous luggage articles that are permanently affixed to or temporarily stowed on the exterior surface of the RV roof.

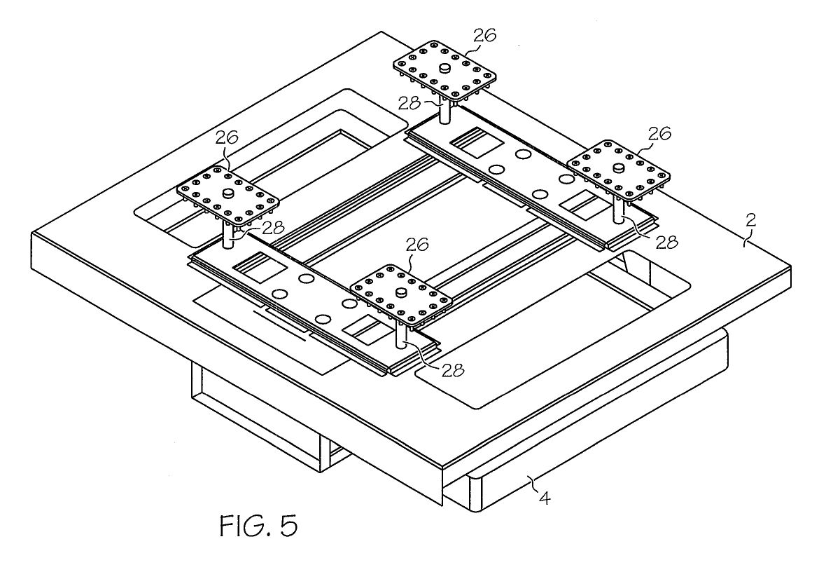

The present invention includes features for coupling a large and heavy display screen to an overhead structure in a manner that is particularly well-suited to the structural characteristics particular to RVS. As illustrated and explained in further detail with reference to FIGS. 4-6, multiple mounting plates disposed on the exterior surface of an exterior roof surface are utilized in conjunction with adjustable length studs to provide load bearing support. Referring now to FIGS. 4 and 5, there are depicted a forward facing and perspective view of a display screen mount apparatus 25 mounted within a vehicle interior in accordance with the present invention. Similar to the previously depicted embodiment, display screen mount apparatus 25 generally comprises display screen 4 coupled to and supported by support frame 14 which is coupled to mounting frame 2 via the slide assembly. FIG. 4 depicts apparatus 25 coupled to a roof structure disposed between an external roof surface 24 and an opposing interior ceiling surface 22. As mentioned above the roof structure between external surface 24 and ceiling surface 22 typically comprises multiple interleaved insulation and containment layers providing various thermal insulation as well as structural integrity functions and which are generally fabricated in an arched formation as shown in FIG. 4 to enhance the structural integrity and load bearing capacity of the structure.

In a further RV-specific structural characteristic aimed at minimizing overall vehicle weight, external roof surface 24 is preferably formed as a relatively thin and lightweight sheet material such as a polymer or metal alloy. Given the relative thin and lightweight external roof layer, a waterproof bonding agent is preferably used to adhesively attach each of support plates 26 to external roof surface 24. In such an embodiment, attachment screws 23 provide mechanical coupling means that couple support plates 26 to external roof surface 24 while the adhesive bonding agent cures. The use of multiple, independently positioned support plates 26 in concert with the use of a bonding agent coupling to the external roof surface 24 provides a particularly robust and advantageous coupling interface that accounts for the aforementioned structural attributes of RVs in a dynamic environment in which considerable inertial factors are otherwise not adequately accounted for.

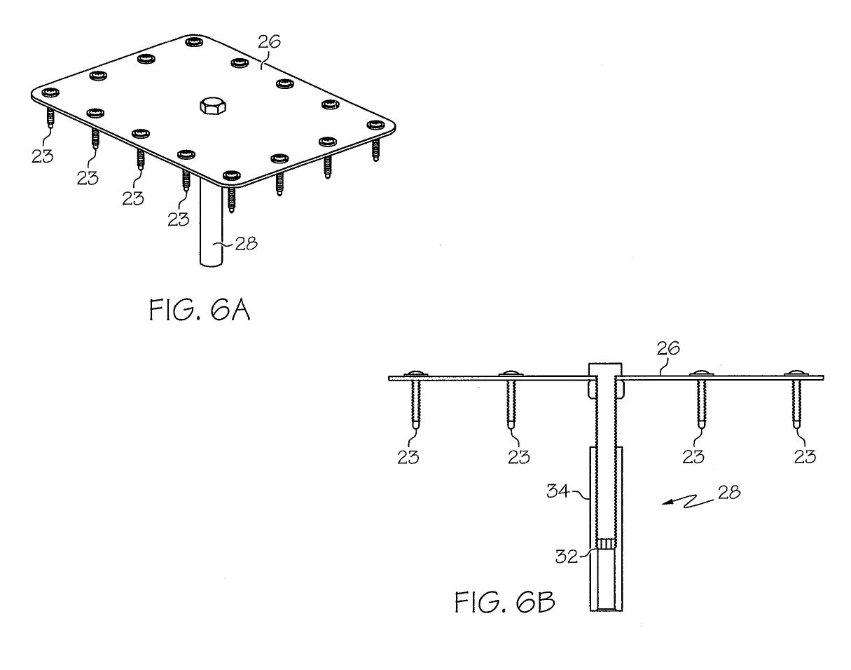

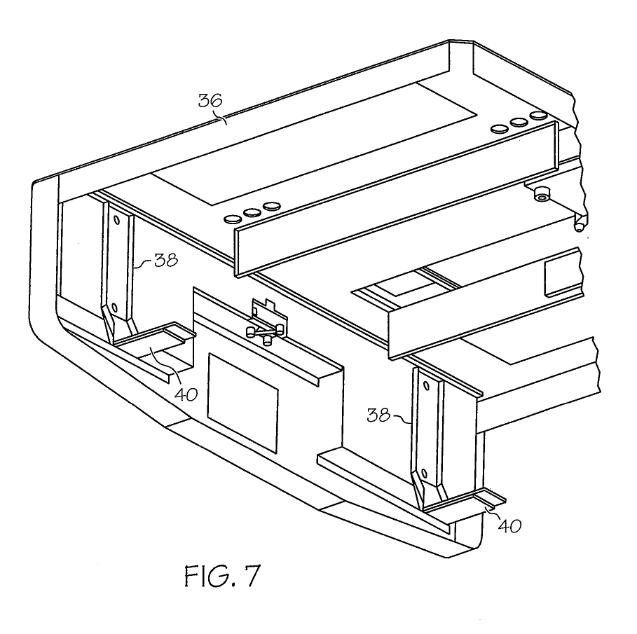

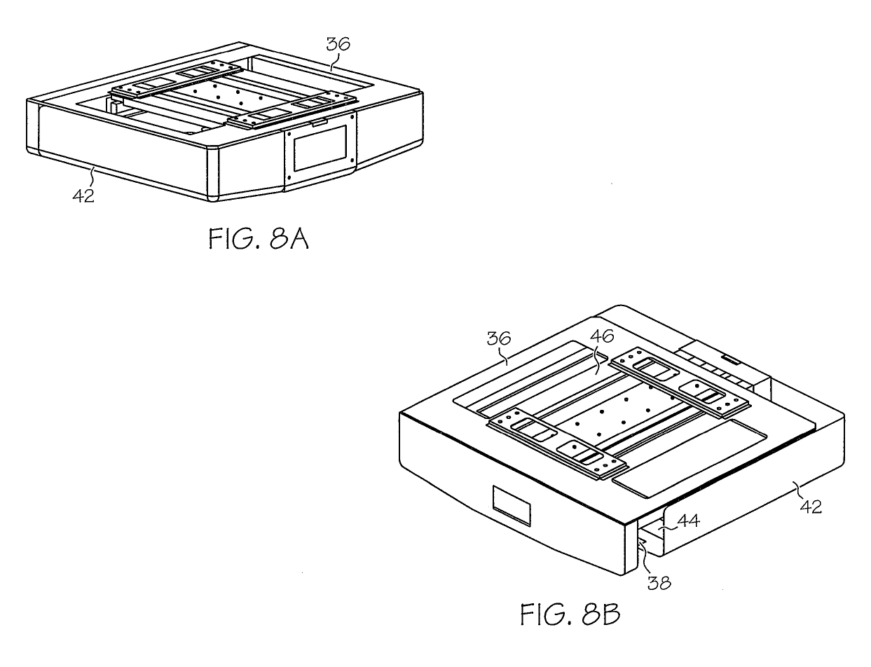

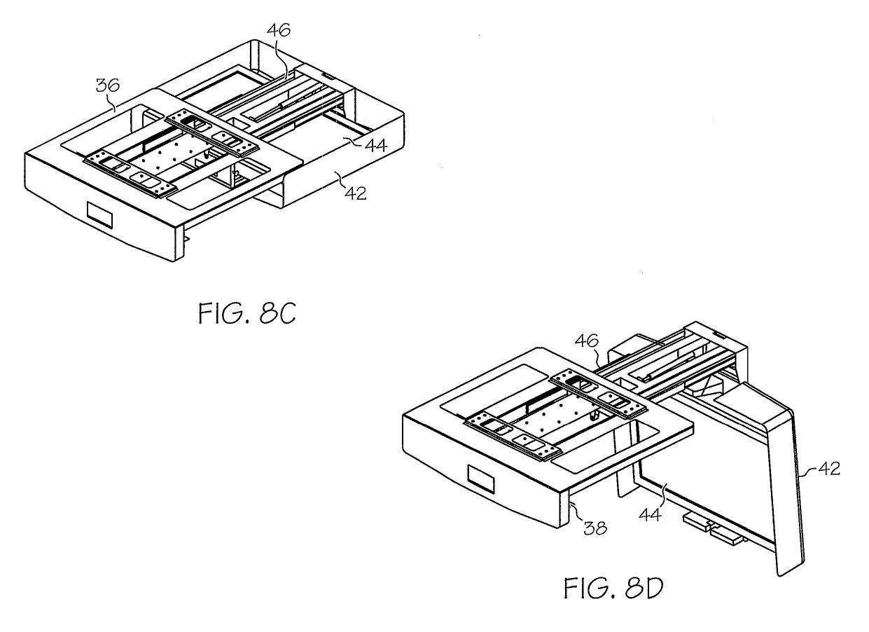

As shown in FIGS. 4 and 5, an attachment interface comprising multiple support plates 26 and adjustable length studs 28 is utilized for coupling and supporting mounting frame 2 from an exterior roof surface 24. Adjustable length studs 28 allow individual lengthwise adjustment, thus permitting mounting frame 2 to be positioned below and in substantial abutment with a slightly arched or cambered ceiling surface 22. In the depicted embodiment, mounting frame 2 includes four mounting sites for receiving four adjustable length studs 28. The opposing ends of adjustable length studs 28 engage support plates 26, which as shown in FIGS. 6A and 6B comprise substantially rectangular plates having attachment screws 23 along the periphery and through which the respective studs are passed so that the head of the studs rests against the outer surface of the plates. With continued reference to FIGS. 6A and 6B, each adjustable length stud 28 comprises a long nut 34 in threaded engagement with an internal locking set screw 32. Long nut 34 is configured as a threaded sleeve having a relative position determined by the setting of internal locking set screw 32. In this manner, and referring again to FIGS. 4 and 5, the length of each of studs 28 may be independently adjusted to compensate for non-uniformities in the mounting sites for each of the respective studs.

FIG. 7 illustrates a partial perspective view of a mounting frame 36 including outrigger panel supports in accordance with a preferred embodiment of the present invention. Mounting frame 36 is structurally and functionally similar to mounting frame 2 depicted in the previous embodiments and further includes a pair of outrigger panel supports 38. In a preferred embodiment, outrigger supports 38 comprise a base portion mechanically coupled to or otherwise fastened to a vertical surface within mounting frame 36. Attached to the base portions are outwardly extending tabs 40 for providing horizontal support surfaces for the display screen assembly when the display screen is folded into the storage position. Tabs 40 are preferably have sufficient flexibility and elasticity to provide a shock absorber function as well as providing horizontal and lateral stability required when the display screen unit is subject to dynamic forces within a moving vehicle.

FIGS. 8A-8D depict views of a display screen mount apparatus in various stages of panel display storage and deployment in accordance with an alternate embodiment of the present invention. The depicted display screen mount apparatus includes many of the same features described above including a slide assembly 46 coupled to mounting frame 36 for horizontally positioning a display screen 44. The depicted apparatus further includes a display screen housing 42 fixedly coupled to display screen 44 via a support frame such as the previously depicted support frame 14 or otherwise. Display screen housing 42 provides a housing recess for receiving display screen 44 such that the housing recess covers the back and lateral sides of the display screen.

While the invention has been particularly shown and described with reference to a preferred embodiment, it will be understood by those skilled in the art that various changes in form and detail may be made therein without departing from the spirit and scope of the invention. These alternate implementations all fall within the scope of the invention.

What is claimed is:

1. A display screen mount apparatus comprising:
a mounting frame having an attachment interface for coupling to a vehicle roof;
a slide assembly having a stationary end fixedly coupled to said mounting frame and having an extensible member that is horizontally extensible from said mounting frame;
a vertical support frame for supporting a display screen, said vertical support frame pivotally coupled to the extensible member of said slide assembly such that said vertical support frame is radially extensible between a horizontal storage position substantially parallel to said slide assembly and a vertically extended display position;
a display screen housing fixedly coupled to said vertical support frame, said display screen housing providing a housing recess for receiving said display screen;
an L-shaped fulcrum lever having a user-actuated arm fixedly coupled to a spring-actuated arm, said user-actuated arm coupled in substantially parallel alignment with said vertical support frame such that said vertical support frame provides cantilevered support to said spring-actuated arm; and
a spring member coupled between and applying an expansive force between said slide assembly and said spring-actuated arm of said L-shaped fulcrum lever.

2. The display screen mount apparatus of claim 1, wherein said spring member is a pneumatically damped spring.

3. The display screen mount apparatus of claim 1, wherein said spring member is a pneumatic spring.

4. The display screen mount apparatus of claim 1, wherein said display screen is fixedly disposed within said housing recess such that said housing recess covers the back and lateral sides of said display screen.

5. The display screen mount apparatus of claim 1, wherein said spring member applies an expansive force between the extensible portion of said slide assembly and said L-shaped fulcrum lever.

6. The display screen mount apparatus of claim 1, wherein said mounting frame is coupled to an attachment interface that includes multiple support plates that provide vertical hanging support from a vehicle roof.

7. The display screen mount apparatus of claim 6, wherein said multiple support plates are adhesively coupled to an exterior surface of said vehicle roof.

8. An apparatus for mounting and positioning a display screen within a vehicle compartment, said apparatus comprising:
a mounting frame having an attachment interface that includes multiple load bearing plates that provide vertical hanging support from a vehicle roof;
a slide assembly having a stationary end fixedly coupled to said mounting frame and having an extensible member that is horizontally extensible from said mounting frame;
a vertical support frame for supporting a display screen, said vertical support frame pivotally coupled to the extensible member of said slide assembly such that said vertical support frame is radially extensible between a horizontal storage position substantially parallel to said slide assembly and a vertically extended display position;
a display screen housing fixedly coupled to said vertical support frame, said display screen housing providing a housing recess for receiving said display screen;
an L-shaped fulcrum lever having a user-actuated arm fixedly coupled to a spring-actuated arm, said user-actuated arm coupled in substantially parallel alignment with said vertical support frame such that said vertical support frame provides cantilevered support to said spring-actuated arm; and
a spring member coupled between and applying an expansive force between said slide assembly and said spring-actuated arm of said L-shaped fulcrum lever.

9. The display screen mount apparatus of claim 8, wherein said spring member is a pneumatically damped spring.

10. The display screen mount apparatus of claim 8, wherein said spring member is a pneumatic spring.

11. The display screen mount apparatus of claim 8, wherein said display screen is fixedly disposed within said housing recess such that said housing recess covers the back and lateral sides of said display screen.

12. The display screen mount apparatus of claim 8, wherein said spring member applies an expansive force between the extensible portion of said slide assembly and said L-shaped fulcrum lever.

13. An apparatus for mounting a flat panel display screen within a vehicle compartment, wherein said vehicle compartment includes an arched roof structure comprising multiple insulating layers disposed between an exterior roof skin layer and an interior ceiling surface, wherein the exterior roof skin layer is a thin protective sheet and said insulating layers comprise at least a 3 inch thick insulation foam layer, said apparatus comprising:
multiple support plates adhesively coupled using an adhesive and waterproof bonding agent to an exterior surface of said exterior roof layer;
a mounting frame positioned adjacent said interior ceiling surface;
an adjustable length stud member engaged with and extending downwardly from each of the multiple support plates through said roof structure and engaging said mounting frame in a manner such that said adjustable length stud members translate the load from said mounting frame to said multiple support plates;
a slide assembly having a stationary end fixedly coupled to said mounting frame and having an extensible member that is horizontally extensible from said mounting frame; and
a vertical support frame for supporting a display screen, said vertical support frame pivotally coupled to the extensible member of said slide assembly such that said vertical support frame is radially extensible between a horizontal storage position substantially parallel to said slide assembly and a vertically extended display position.

14. The apparatus of claim 13, wherein said exterior roof skin layer is insufficiently thick to support dynamic load bearing mechanical fasteners.

15. The apparatus of claim 13, further comprising a display screen housing fixedly coupled to said vertical support frame, said display screen housing providing a housing recess for receiving said display screen.

16. The apparatus of claim 15, wherein said display screen is fixedly disposed within said housing recess such that said housing recess covers the back and lateral sides of said display screen.

17. The apparatus of claim 13, further comprising an L-shaped fulcrum lever having a user-actuated arm fixedly coupled to a spring-actuated arm, said user-actuated arm coupled in substantially parallel alignment with said vertical support frame such that said vertical support frame provides cantilevered support to said spring-actuated arm.

18. The apparatus of claim 17, further comprising a spring member coupled between and applying an expansive force between said slide assembly and said spring-actuated arm of said L-shaped fulcrum lever.

19. The apparatus of claim 18, wherein said spring member is a pneumatically damped spring.

20. The apparatus of claim 19, wherein said spring member applies an expansive force between the extensible portion of said slide assembly and said L-shaped fulcrum lever.
